(19) United States
(12) Patent Application Publication
(10) Pub. No.: US 2017/0146138 A1
(43) Pub. Date: May 25, 2017

(54) Multi-Position Fluid Valve

(71) Applicant: Weifeng WU, Eastvale, CA (US)

(72) Inventor: Weifeng WU, Eastvale, CA (US)

(21) Appl. No.: 14/948,307

(22) Filed: Nov. 21, 2015

(51) Int. Cl. F16K 11/06; F16K 31/60; F16K 37/00; F16K 27/04

(52) U.S. Cl. CPC F16K 11/06; F16K 27/04; F16K 31/60; F16K 37/0016

(57) ABSTRACT

A multi-position fluid valve includes a valve body, a guiding member and an actuator. The valve body has having a main portion, a fluid inlet, a first fluid outlet and a second fluid outlet. The guiding member is movably received in the main portion, and includes a guider body. The guider body has a guiding inlet, a first guiding outlet and a second guiding outlet. The guiding inlet communicates with the fluid inlet. The first guiding outlet selectively communicates with the first fluid outlet. The second guiding outlet selectively communicates with the second fluid outlet. The actuator is connected to the guiding member and operatively mounted on the valve body to selectively move between at least a fully-closed position, a first single opening position, and a fully-opened position.

### BACKGROUND OF THE PRESENT INVENTION

Field of Invention

The present invention relates to a multi-position fluid valve, and more particularly to a multi-position fluid valve which is capable of selectively guiding fluid to pass through from a fluid inlet to at least one fluid outlet.

Description of Related Arts

A conventional valve for fluid (such as water) usually comprises a valve body having a fluid inlet, a plurality of fluid outlets, and an actuator provided on the valve body for controlling the flow of fluid between the fluid inlet and the fluid outlets. The actuator may be switched by the user for selectively closing or opening the valve.

A major disadvantage of the conventional valve described above is that when the valve is opened, the fluid such as water will flow from the fluid inlet to both of the fluid outlets. As a result, the user has no way to flexibly control which of the fluid outlets should be opened. For example, when the actuator is switched and the valve is opened, the fluid will go out of the valve body through both of the fluid outlets.

As a result, there is a need to develop a multi-position fluid valve which is capable of allowing fluid to pass from the fluid inlet to one or some of the fluid outlets.

### SUMMARY OF THE PRESENT INVENTION

Certain variations of the present invention provide a multi-position fluid valve which is capable of selectively guiding fluid to pass from a fluid inlet to at least one fluid outlet.

Certain variations of the present invention provide a multi-position fluid valve comprising a valve body and an actuator. By actuating the actuator, a user is able to selectively pick which one of the fluid outlets should be opened for allowing fluid passage.

Certain variations of the present invention provide a multi-position fluid valve which may comprise a fluid inlet and a plurality of fluid outlets, wherein the fluid outlets are provided on the valve body at different orientations so as to selectively allow the fluid to be delivered to different corresponding destinations.

Certain variations of the present invention provide a multi-position fluid valve, comprising:

a valve body having a main portion, a fluid inlet, a first fluid outlet and a second fluid outlet;

a guiding member movably received in the main portion, the guiding member comprising a guider body, the guider body having a guiding inlet, a first guiding outlet and a second guiding outlet; the guiding inlet communicating with the fluid inlet, the first guiding outlet selectively communicating with the first fluid outlet, the second guiding outlet selectively communicating with the second fluid outlet; and

an actuator connected to the guiding member and operatively mounted on the valve body to selectively move between at least a fully-closed position, a first single opening position, and a fully-opened position,

wherein in the fully-closed position, the tubular guiding body is moved by the actuator such that the first guiding outlet and the second guiding outlet are not arranged to communicate with the first fluid outlet and the second fluid outlet respectively,

wherein in the fully-opened position, the tubular guiding body is moved by the actuator such that the first guiding outlet and the second guiding outlet are arranged to communicate with the first fluid outlet and the second fluid outlet respectively,

wherein in the first single opening position, the tubular guiding body is moved by the actuator such that one of the first guiding outlet and the second guiding outlet is arranged to communicate with one of the corresponding first fluid outlet and the second fluid outlet.

This summary presented above is provided merely to introduce certain concepts and not to necessarily identify any key or essential features of the claimed subject matter.

### BRIEF DESCRIPTION OF THE DRAWINGS

FIG. 1 is a perspective view of a multi-position fluid valve according to a preferred embodiment of the present invention.

FIG. 2 is an exploded schematic diagram of the multi-position fluid valve according to the preferred embodiment of the present invention.

FIG. 3 is a sectional side view of the multi-position fluid valve according to the preferred embodiment of the present invention.

FIG. 4 is a schematic diagram of the multi-position fluid valve according to the preferred embodiment of the present invention, illustrating that an actuator is detached from a valve body.

FIG. 5A to FIG. 5D are schematic diagrams of the multi-position fluid valve according to the preferred embodiment of the present invention, illustrating the corresponding fluid flow path when a guiding member is in a fully-closed position, a fully-opened position, a first single opening position, and a dual opening position respectively.

FIG. 6 is a side view of a guiding member of the multi-position fluid valve according to the preferred embodiment of the present invention.

FIG. 7 is a perspective view of the actuator of the multi-position fluid valve according to the preferred embodiment of the present invention.

FIG. 8 is a side view of the actuator of the multi-position fluid valve according to the preferred embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

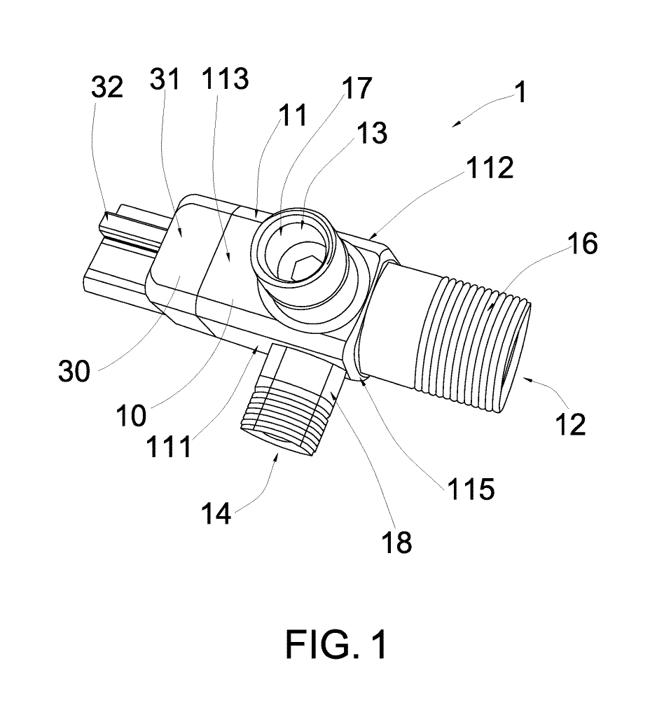

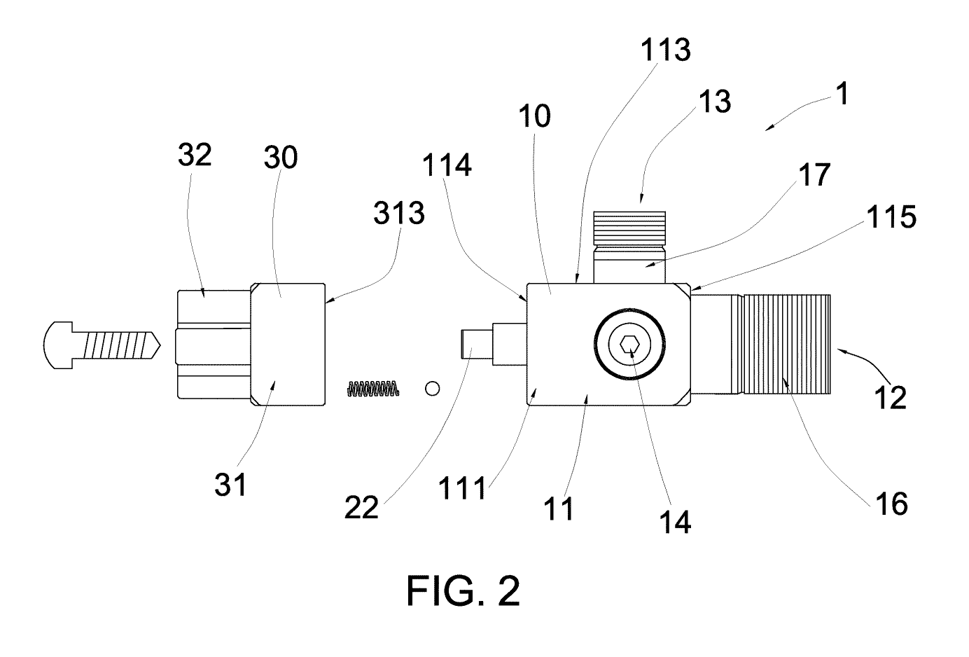

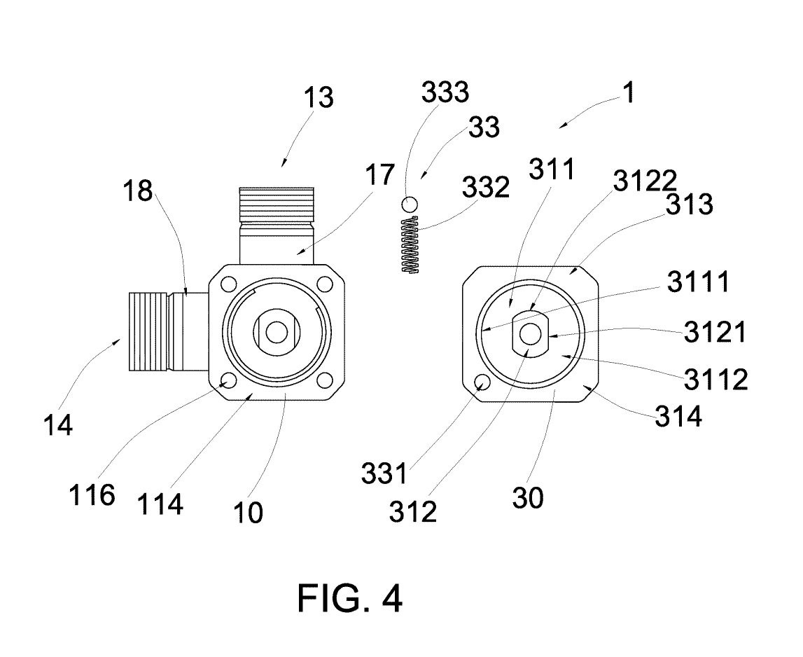

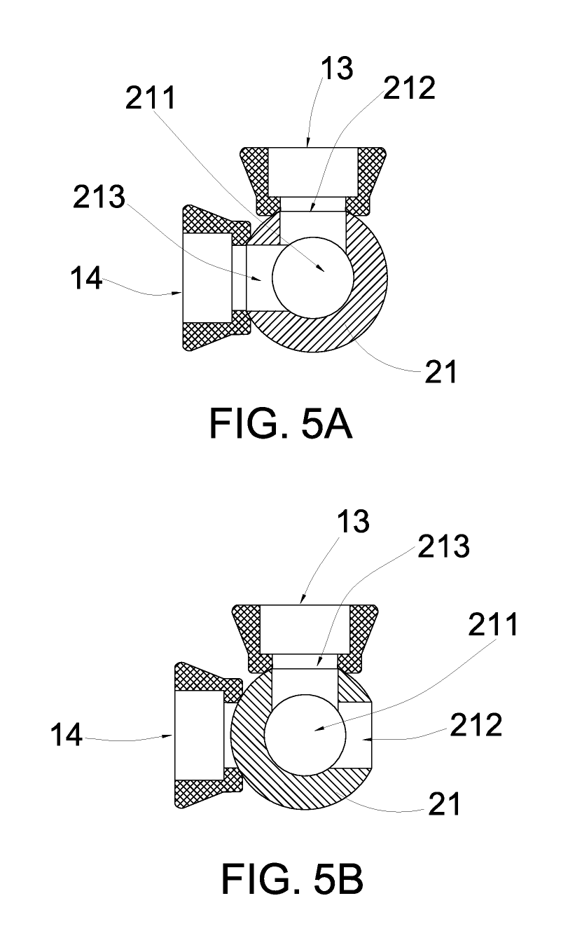

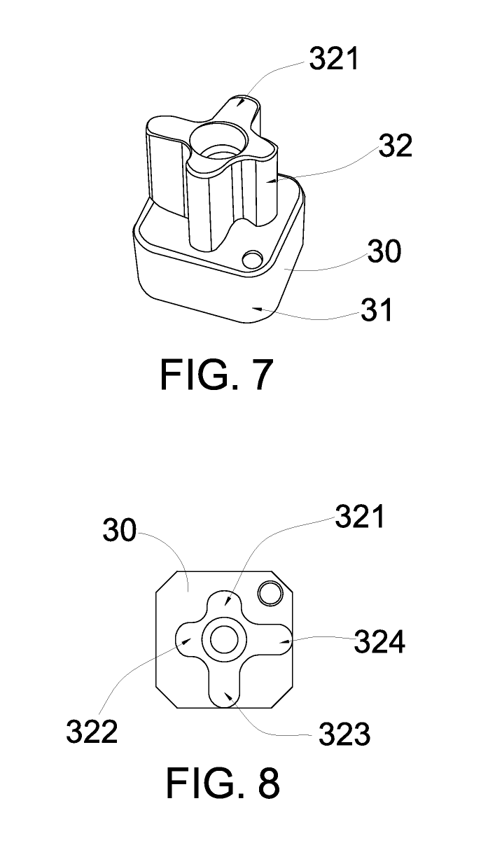

Referring to FIG. 1 to FIG. 4, FIG. 5A to FIG. 5D and FIG. 6 to FIG. 8 of the drawings, a multi-position fluid valve 1 according to a preferred embodiment of the present invention is illustrated. Broadly, the multi-position fluid valve 1 may comprise a valve body 10, a guiding member 20 and an actuator 30. The multi-position fluid valve 1 may be utilized for regulating the flow of fluid, such as water or other liquids.

The valve body 10 may have a main portion 11, a fluid inlet 12, a first fluid outlet 13 and a second fluid outlet 14.

The guiding member 20 may be movably received in the main portion 11, and may comprise a guider body 21. The guider body 21 may have a guiding inlet 211, a first guiding outlet 212 and a second guiding outlet 213. The guiding inlet 211 may communicate with the fluid inlet 12. The first guiding outlet 212 may selectively communicate with the first fluid outlet 13. The second guiding outlet 213 may selectively communicate with the second fluid outlet 14.

The actuator 30 may be connected to the guiding member 20 and operatively mounted on the valve body 10 to selectively move between a fully-closed position, a first single opening position, and a fully-opened position.

In the fully-closed position, the tubular guiding body 21 may be moved by the actuator 30 such that the first guiding outlet 212 and the second guiding outlet 213 are arranged not to communicate with the first fluid outlet 13 and the second fluid outlet respectively 14. The result is that the fluid from the fluid inlet 12 may be prevented from passing through the multi-position fluid valve 1 of the present invention. This situation is illustrated in FIG. 5C of the drawings.

In the fully-opened position, the tubular guiding body 21 may be moved by the actuator 30 such that the first guiding outlet 212 and the second guiding outlet 213 are arranged to communicate with the first fluid outlet 13 and the second fluid outlet 14 respectively. The result is that the fluid from the fluid inlet 12 may be guided to flow out of the multi-position fluid valve through the first fluid outlet 13 and the second fluid outlet 14. This situation is illustrated in FIG. 5A of the drawings.

In the single opening position, the tubular guiding body 21 may be moved by the actuator 30 such that one of the first guiding outlet 212 and the second guiding outlet 213 is arranged to communicate with the corresponding first fluid outlet 13 or the second fluid outlet 14. The result is that the fluid from the fluid inlet 12 may be guided to flow out of the multi-position fluid valve through one of the first fluid outlet 13 and the second fluid outlet 14. This situation is illustrated in FIG. 5B and FIG. 5D of the drawings.

According to the preferred embodiment of the present invention, the valve body 10 may be made of metallic material. The main portion 11 of the valve body 10 may have a rectangular cross sectional shape. The valve body 10 may have a receiving cavity 15 defined as a space within the valve body 11. The receiving cavity 15 may communicate with the fluid inlet 12, the first fluid outlet 13 and the second fluid outlet 14. As shown in FIG. 1 to FIG. 3 of the drawings, the main portion 11 of the valve body 10 may be defined to have a front surface 111, a rear surface 112, a top surface 113, a first side surface 114 and a second side surface 115.

The valve body 10 may further have an inlet portion 16 sidewardly extended from the second side surface 115 of the main portion 11 along a longitudinal direction of the valve body 10, wherein the fluid inlet 12 may be provided on the inlet portion 16 of the valve body 10. The inlet portion 16 of the valve body 10 may be configured to have a circular cross section and may have an externally threaded portion 161 for allowing a user to conveniently connect the valve body 10 with a fluid pipe. The receiving cavity 15 may extend across the main portion 11 and the inlet portion 16.

Similarly, the valve body 10 may further have a first outlet portion 17 and a second outlet portion 18 extended from the top surface 113 and the front surface 111 of the valve body 10 respectively, wherein the first fluid outlet 13 and the second fluid outlet 14 may be formed on the first outlet portion 17 and the second outlet portion 18 respectively. Fluid such as water coming from the fluid inlet 12 may be selectively guided to flow out of the valve body 10 through at least one of the first fluid outlet 13 and the second fluid outlet 14. Each of the first outlet portion 17 and the second outlet portion 18 may have a circular cross section.

The fluid inlet 12 may be formed at an orientation which is perpendicular to the longitudinal axis of the valve body 10. On the other hand, the first fluid outlet 13 and the second fluid outlet 14 may be formed at an orientation which is perpendicular to a transverse axis of the valve body 10.

The guiding member 20 may further comprise a connecting member 22 extended from the guider body 21 to operatively connect to the actuator 30, in such a manner that a rotational movement of the actuator 30 is arranged to drive the guider body 21 to rotate in a corresponding direction. The guider body 21 may have a circular cross section in which an external diameter of the guider body 21 may be slightly less than that of an internal diameter of the receiving cavity 15 of the main portion 11 of the valve body 10 so that the guider body 21 may be fittedly yet rotatably supported in the main portion 11 of the valve body 10. In the preferred embodiment of the present invention, both the actuator 30 and the guider body 21 may rotate about a longitudinal direction of the valve body 10.

Specifically, the guider body 21 may have a substantially spherically external shape so as to minimize contact surface area between the guider body 21 and the valve body 10. The result is to minimize the frictional force between the guider body 21 and the valve body 10 when the guider body 21 is rotated.

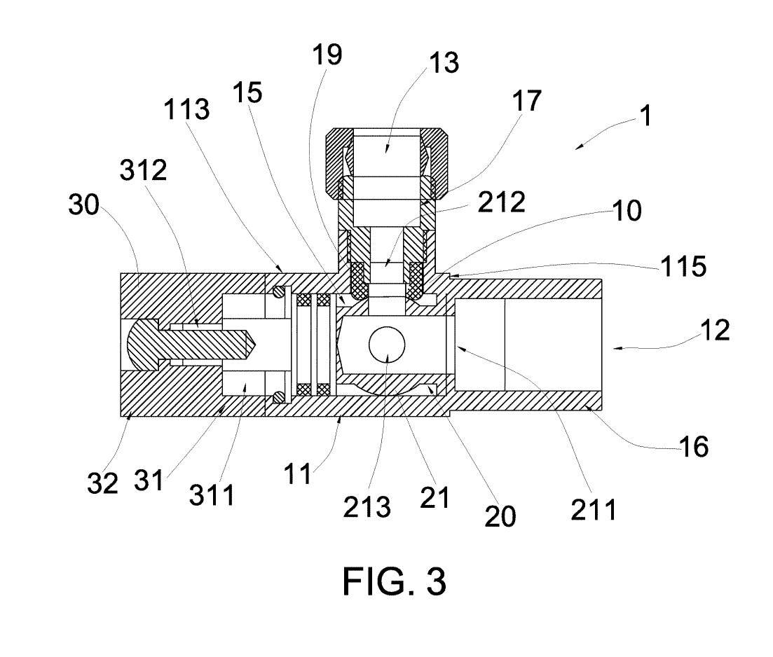

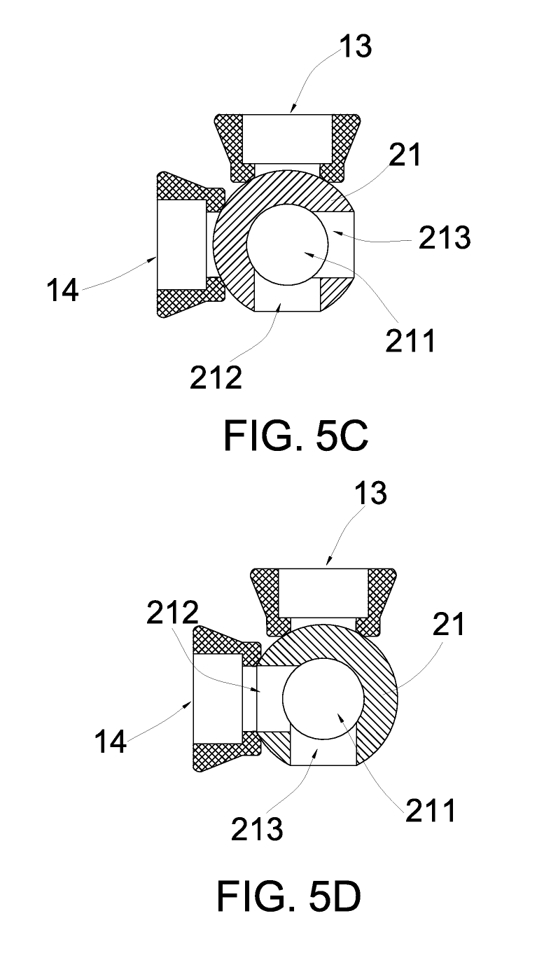

As shown in FIG. 3, FIG. 5A to FIG. 5D and FIG. 6 of the drawings, the guiding inlet 211 may be formed at an orientation which is perpendicular to the longitudinal axis of the guider body 21. The first guiding outlet 212 and the second guiding outlet 213 may be formed at an orientation which is perpendicular to a transverse axis of the guider body 21.

One may then appreciate that when the guider body 21 is rotated, the first guiding outlet 212 and the second guiding outlet 213 will also be rotated accordingly. When the first guiding outlet 212 and the second guiding outlet 213 are rotated, they will be selectively offset from the first fluid outlet 13 and the second fluid outlet 14 so as to selectively control the flow of water between the fluid inlet 12 and at least one of the first fluid outlet 13 and the second fluid outlet 14. The guider body 21 may be rotated to sequentially move between the fully-opened position, the single-opening position, and the fully-closed opened position.

It is worth mentioning that the guider body 21 may also be moved to a second single opening position. In this second single opening position, the tubular guiding body 21 is moved by the actuator 30 such that the one of the first guiding outlet 212 and the second guiding outlet 213 is arranged to communicate with a corresponding first fluid outlet 13 or the second fluid outlet 14.

In the preferred embodiment of the present invention, when the guider body 21 is in the first single opening position, the second guiding outlet 213 is arranged to communicate with the first fluid outlet 13 while the first guiding outlet 212 is prevented from communicating with the second fluid outlet 14 so that fluid may only exit the valve body 10 through the first fluid outlet 13, as shown in FIG. 5B of the drawings.

On the other hand, when the guider body 21 is in the second single opening position, the first guiding outlet 212 is arranged to communicate with the second fluid outlet 14 while the second guiding outlet 213 is prevented from communicating with the first fluid outlet 13 so that fluid may only exit the valve body 10 through the second fluid outlet 14.

The guider body 21 may be rotated to sequentially move from the fully-opening position, the first single opening position, the fully-closed position, and the second single opening position. This sequence is illustrated in FIG. 5A to FIG. 5D of the drawings. The valve body 10 may further comprise a sealing element 19 provided in the valve 11 for providing sealing of fluid between the valve body 10 and the guiding member 20.

The actuator 30 may comprise a body portion 31 and a handle portion 32 for allowing a user to conveniently rotate the actuator body 31 through rotating the actuating handle 32. The body portion 31 may have an engagement cavity 311 indently formed from an inner end 313 thereof. The engagement cavity 311 may have a substantially circular cross section and may be surrounded by a peripheral sidewall 3111 and a biasing wall 3112.

The body portion 31 of the actuator 30 may further have an engagement slot 312 formed on the biasing wall 3112. The connecting member 22 may engage with the engagement slot 312 in such a way that when the actuator 30 rotates, the connecting member 22 will also be driven to rotate accordingly.

The engagement slot 312 may have a quadrilateral cross sectional shape and may be surrounded by two flat side surfaces 3121 and two curved surfaces 3122. The connecting member 22 may have an elongated portion 221 and an engagement end portion 222, wherein the elongated portion 221 may have a circular cross section, while the engagement end portion 222 may have a cross sectional shape which is corresponding to that of the engagement slot 312. Two biasing shoulders 223 may be formed at the boundary between the elongated portion 221 and the engagement end portion 222. When the actuator 30 is engaged with the guiding member 20, the engagement end portion 222 of the connecting member 22 may be inserted into the engagement slot 312. Further movement of the actuator 30 in the direction towards the valve body 10 may be blocked by the biasing shoulders 221, which may positioned to bias against the biasing wall 3112 of the engagement cavity 311.

The actuator 30 may further comprise a securing arrangement 33 provided on the body portion 31 for rotatably connecting the body portion 31 to the valve body 10. Specifically, the securing arrangement 33 may contain a securing slot 331 indently formed on an inner side surface 314 of the body portion 31, and comprise a resilient element 332 received in the securing slot 331, and a spherical member 333 received in the securing slot 331, and may be normally biased by the resilient element 332. The securing slot 331 may be positioned at one of the corner portions of the inner side surface 314 of the body portion 31. When the actuator 30 rotates, the securing slot 331 will also move relative to the valve body 10.

The main portion 11 of the valve body 10 may further contain a plurality of spherically shaped indentions 116 spacedly formed on the first side surface 114 of the main portion 11 of the valve body 10. The spherically shaped indentions 116 may be positioned to correspond to the position of the securing slot 331 as the actuator 30 rotates.

The function of the securing arrangement 33 is for securing the position of the actuator 3 and for facilitate smooth rotation of the actuator 30. A diameter of the spherical member 333 may be slightly greater that of the spherically shaped indentions 116 but slightly smaller than that of the securing slot 331. When the actuator 30 is rotated such that the securing slot 331 is aligned or communicate with one of the spherically shaped indentions 116, the spherical member 333 will be pushed by the resilient element 332 to bias against and partially sit in the corresponding spherically shaped indention 116. When the spherical member 333 sits in the spherically shaped indentions 116, the position of the actuator 30 will be substantially secured. Note that the spherically shaped indentions 116 are positioned to correspond to the fully-opening position, first single opening position, the fully-closed position, and the second single opening position of the guider body 21 respectively.

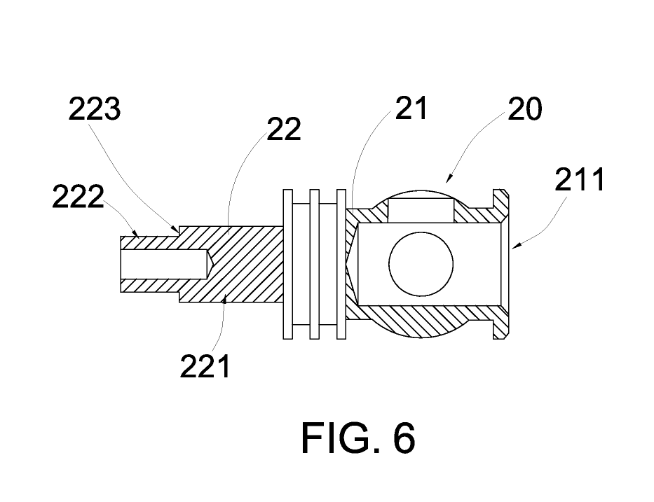

It is worth mentioning that the handle portion 32 of the actuator 30 may be designed to form a plurality of indicating members. Referring to FIG. 7 of the drawings, there may exist first through four indicating members 321, 322, 323, 324 formed as the handle portion 32. Each of the indicating members 321, 322, 323, 324 have may a predetermined length for allowing a user of the present invention to visually recognize the opening status of the first fluid outlet 13 and the second fluid outlet 14. In this preferred embodiment, the first and the second indicating members 321, 322 may have an equal length which is shorter than that of the third and the fourth indicating members 323, 324. The first indicating member 321 is aligned but opposite to the third indicating member 323, while the second indicating member 322 is align but opposite to the fourth indicating member 324. The first and the second indicating member 321, 322 may point toward a fluid outlet which is opened for fluid passage. On the other hand, the third and the fourth indicating member 323, 324 may point toward a fluid outlet which is closed for fluid passage.

The present invention, while illustrated and described in terms of a preferred embodiment and several alternatives, is not limited to the particular description contained in this specification. Additional alternative or equivalent components could also be used to practice the present invention.

What is claimed is:

1. A multi-position fluid valve, comprising:
a valve body having a main portion, a fluid inlet, a first fluid outlet and a second fluid outlet;
a guiding member movably received in said main portion, said guiding member comprising a guider body, said guider body having a guiding inlet, a first guiding outlet and a second guiding outlet; said guiding inlet communicating with said fluid inlet, said first guiding outlet selectively communicating with said first fluid outlet, said second guiding outlet selectively communicating with said second fluid outlet; and
an actuator connected to said guiding member and operatively mounted on said valve body to selectively move between at least a fully-closed position, a first single opening position, and a fully-opened position,
wherein in said fully-closed position, said tubular guiding body is moved by said actuator such that said first guiding outlet and said second guiding outlet are not arranged to communicate with said first fluid outlet and said second fluid outlet respectively,
wherein in said fully-opened position, said tubular guiding body is moved by said actuator such that said first guiding outlet and said second guiding outlet are arranged to communicate with said first fluid outlet and said second fluid outlet respectively,
wherein in said first single opening position, said tubular guiding body is moved by said actuator such that one of said first guiding outlet and said second guiding outlet is arranged to communicate with one of said corresponding first fluid outlet and said second fluid outlet.

2. The multi-position fluid valve, as recited in claim 1, wherein said valve body has a receiving cavity defined as a space within said valve body, said receiving cavity communicating with said fluid inlet, said first fluid outlet and said second fluid outlet, said main portion of said valve body having a front surface, a rear surface, a top surface, a first side surface and a second side surface.

3. The multi-position fluid valve, as recited in claim 2, wherein said valve body further has an inlet portion sidewardly extended from said second side surface of said main portion along a longitudinal direction of said valve body, wherein said fluid inlet is provided on said inlet portion of said valve body.

4. The multi-position fluid valve, as recited in claim 3, wherein said valve body further has a first outlet portion and a second outlet portion extended from said top surface and said front surface of said valve body respectively, wherein said first fluid outlet and said second fluid outlet are formed on said first outlet portion and said second outlet portion respectively.

5. The multi-position fluid valve, as recited in claim 1, wherein said guiding member further comprises a connecting member extended from said guider body to operatively connect to said actuator, in such a manner that a rotational movement of said actuator is arranged to drive said guider body to rotate in a corresponding direction.

6. The multi-position fluid valve, as recited in claim 1, wherein said guider body is arranged to selectively move to a second single opening position, wherein in said second single opening position, one of said first guiding outlet and said second guiding outlet is arranged to communicate with a corresponding first fluid outlet or said second fluid outlet.

7. The multi-position fluid valve, as recited in claim 6, wherein when said guider body is in said first single opening position, said second guiding outlet is arranged to communicate with said first fluid outlet while said first guiding outlet is prevented from communicating with said second fluid outlet, wherein when said guider body is in said second single opening position, said first guiding outlet is arranged to communicate with said second fluid outlet while said second guiding outlet is prevented from communicating with said first fluid outlet.

8. The multi-position fluid valve, as recited in claim 7, wherein said guider body has a substantially spherically external shape so as to minimize contact surface area between said guider body and said valve body.

9. The multi-position fluid valve, as recited in claim 8, wherein said first guiding outlet and said second guiding outlet are positioned such that said guider body is arranged to sequentially move from said fully-opening position, to said first single opening position, said fully-closed position, and said second single opening position.

10. The multi-position fluid valve, as recited in claim 1, wherein said actuator comprises a body portion and a handle portion, said body portion having an engagement cavity indently formed on an inner end thereof, said engagement cavity having a substantially circular cross section and being surrounded by a peripheral sidewall and a biasing wall.

11. The multi-position fluid valve, as recited in claim 9, wherein said actuator comprises a body portion and a handle portion, said body portion having an engagement cavity indently formed on an inner end thereof, said engagement cavity having a substantially circular cross section and being surrounded by a peripheral sidewall and a biasing wall.

12. The multi-position fluid valve, as recited in claim 10, wherein said body portion of said actuator further has an engagement slot formed on said biasing wall, said connecting member being arranged to engage with said engagement slot in such a way that when said actuator rotates, said connecting member is driven to rotate accordingly.

13. The multi-position fluid valve, as recited in claim 11, wherein said body portion of said actuator further has an engagement slot formed on said biasing wall, said connecting member being arranged to engage with said engagement slot in such a way that when said actuator rotates, said connecting member is driven to rotate accordingly.

14. The multi-position fluid valve, as recited in claim 12, wherein said engagement slot has a quadrilateral cross sectional shape and is surrounded by two flat side surfaces and two curved surfaces, said connecting member having an elongated portion and an engagement end portion, wherein said engagement end portion has a cross sectional shape which is corresponding to that of said engagement slot, said connecting member further having two biasing shoulders formed at a boundary between said elongated portion and said engagement end portion.

15. The multi-position fluid valve, as recited in claim 13, wherein said engagement slot has a quadrilateral cross sectional shape and is surrounded by two flat side surfaces and two curved surfaces, said connecting member having an elongated portion and an engagement end portion, wherein said engagement end portion has a cross sectional shape which is corresponding to that of said engagement slot, said connecting member further having two biasing shoulders formed at a boundary between said elongated portion and said engagement end portion

16. The multi-position fluid valve, as recited in claim 14, wherein said actuator further comprises a securing arrangement which contains a securing slot indently formed on an inner side surface of said body portion, and comprise a resilient element received in said securing slot, and a spherical member received in said securing slot, said spherical member being normally biased by said resilient element, said main portion of said valve body further having a plurality of spherically shaped indentions spacedly formed on said first side surface of said main portion, said spherically shaped indentions being positioned to correspond to said position of said securing slot as said actuator rotates.

17. The multi-position fluid valve, as recited in claim 15, wherein said actuator further comprises a securing arrangement which contains a securing slot indently formed on an inner side surface of said body portion, and comprise a resilient element received in said securing slot, and a spherical member received in said securing slot, said spherical member being normally biased by said resilient element, said main portion of said valve body further having a plurality of spherically shaped indentions spacedly formed on said first side surface of said main portion, said spherically shaped indentions being positioned to correspond to said position of said securing slot as said actuator rotates.

18. The multi-position fluid valve, as recited in claim 16, wherein said handle portion of said actuator forms first through fourth indicating members, said first and said second indicating members having an equal length which is shorter than that of said third and said fourth indicating members, said first indicating member being aligned with and opposite to said third indicating member, while said second indicating member being aligned with and opposite to said fourth indicating member.

19. The multi-position fluid valve, as recited in claim 17, wherein said handle portion of said actuator forms first through fourth indicating members, said first and said second indicating members having an equal length which is shorter than that of said third and said fourth indicating members, said first indicating member being aligned with and opposite to said third indicating member, while said second indicating member being aligned with and opposite to said fourth indicating member.

20. The multi-position fluid valve, as recited in claim 9, wherein said fluid inlet and said guiding inlet are formed at an orientation which is perpendicular to the longitudinal axis of the valve body, said first fluid outlet, said second fluid outlet, said first guiding outlet and said second guiding outlet being formed at an orientation which is perpendicular to a transverse axis of the guider body.
